(19) United States
(12) Patent Application Publication
(10) Pub. No.: US 2009/0075676 A1
(43) Pub. Date: Mar. 19, 2009

(54) SYSTEM AND METHOD FOR MANAGING LOCATION INFORMATION FOR HOME NETWORK

(75) Inventors: Jun Hee Park, Daejeon (KR); Tai-Yeon Ku, Busan (KR); Kyeong-Deok Moon, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/185,349

(22) Filed: Aug. 4, 2008

(30) Foreign Application Priority Data
Sep. 19, 2007 (KR) 10-2007-95508

(51) Int. Cl. H04W 4/02

(52) U.S. Cl. 455/456.3

(57) ABSTRACT

Provided are a system and method for managing location information for a home network. The system includes a device management means for collecting information of home network devices to form a device table, a location management means for generating a space data structure including a gridded home floor plan, and associating the device table with the space data structure on the basis of a location of the home network device, and a user interface module for receiving a location of the home network device to transfer the input location information to the location management means. Since location information of the home network devices is directly input, accurate location-based home network services can be provided.

### CROSS-REFERENCE TO RELATED APPLICATIONS

This application claims priority under 35 U.S.C. §119 to Korean Patent Application No. 10-2007-95508, filed on Sep. 19, 2007, the disclosure of which is incorporated herein by reference in its entirety.

### BACKGROUND OF THE INVENTION

1. Field of the Invention

The present disclosure relates to a system and method for managing location information for a home network, and more particularly, to a system and method for managing location information for a home network capable of providing an accurate location-based home network service by allowing location information of home network devices to be directly input through a user interface.

This work was supported by the IT R&D program of MIC/IITA [2006-S-066-02, Development of High Reliable Adaptive Middleware for u-Home]

2. Description of the Related Art

Recent development of information technologies has allowed one home network to connect various home network devices such as personal computers (PCs), mobile phones, digital television receivers, personal digital assistants (PDAs), and electronic games. As this network environment is provided into homes, home network techniques are drawing much attention.

The home network technique is directed to providing an environment where home network devices are connected to one network to share digital data and use broadband communication. The home network technique in the narrow sense refers to wired and wireless network equipment that connects home network devices. In the broad sense, the home network technique covers, e.g., services or middleware for convergence/control/operation between home network devices.

A general home gateway system has a limited public Internet Protocol (IP) address to allow home network devices having private IP addresses to access sites connected to the Internet. The home gateway system is assigned a single public IP address, and the home network devices are assigned private IP addresses that external devices are unable to recognize. In order for the home network devices connected with the home gateway system to receive information from an external device, the home gateway system changes the private IP addresses of the home network devices into its public IP address through network address translation (NAT), and transmits/receives data.

Unseen computers and sensors ubiquitously built into our moderns surroundings are connected together by a wired/wireless network, and sense various data to recognize contexts and situations based on the sensed data, thereby providing various services to users. There is no doubt that wireless sensor network techniques and techniques for small-embedded devices will become core technologies in the ubiquitous computing age to come.

One of core concepts of the ubiquitous home network environment is contexts. The first contexts that are being integrated with the home network service among various types of contexts are location contexts. The location contexts can be expressed in various forms in the home network environment. Currently, spatial information shown in a home floor plan is being used. That is, spatial information of, e.g., a living room, a bedroom, a kitchen, a porch, a bathroom, or the front door, which is familiar to a user but has low location accuracy is being used.

To evolve into the future ubiquitous home network environment, methods and techniques for achieving more accurate location information of the home network devices are being improved. Also, many researches are being actively conducted on automatic location determination of the home network devices.

However, it is expected that it will take long time to complete the automatic location determination technique and apply it to the market. Also, it is difficult to apply the current automatic location determination technique to the home network system at this point in time when the home network industry is being just realized

### SUMMARY

Therefore, an object of the present invention is to provide a system and method for managing location information for a home network capable of providing an accurate location-based home network service by allowing location information of home network devices to be directly input through a user interface.

To achieve these and other advantages and in accordance with the purpose(s) of the present invention as embodied and broadly described herein, an apparatus a system for managing location information for a home network in accordance with an aspect of the present invention includes: a device management means for collecting information of home network devices to form a device table; a location management means for generating a space data structure including a gridded home floor plan, and associating the device table with the space data structure on the basis of a location of the home network device; and a user interface module for receiving a location of the home network device to transfer the input location information to the location management means.

The device table may include an index, an identifier, an attribute, and location information of each device.

The location management means may include: an input unit for receiving a home floor plan and dimension information; a space data generating unit for gridding the home floor plan, and generating a two-dimensional space data structure including a bitmap record including two-dimensional coordinates of a grid and a home space pattern where the grid is placed; and a mapping unit for associating the space data structure with the device within the device table on the basis of two-dimensional coordinates of a grid corresponding to the location of the device.

The space data generating unit may grid the home floor plan by applying a bitmap including a plurality of unit pixels to the home floor plan.

When receiving location coordinates of the device, the mapping unit may generate a device record about the device, and associate the device with a corresponding bitmap record on the basis of the device record.

The user input unit may be a pointing means including a mouse or a stylus pen.

To achieve these and other advantages and in accordance with the purpose(s) of the present invention, a method for managing location information for a home network in accordance with another aspect of the present invention includes: receiving a home floor plan and dimension information to grid the home floor plan, and generating a two-dimensional space data structure including a plurality of bitmap records each including two-dimensional coordinates of each grid and a home space pattern in which each grid is placed; collecting information of home network devices to form a device table associated with the two-dimensional space data structure; and receiving input of a location of the home network device through a user interface module to associate the device table with the two-dimensional space data structure on the basis of the input location of the home network device.

The space data structure may include the gridded home floor plan by applying a bitmap including a plurality of unit pixels to the home floor plan.

The device table may include an index, an identifier, an attribute, and location information of each device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a system for managing location information for a home network according to an embodiment of the present invention;

FIG. 2 is a schematic view illustrating a user interface module according to the embodiment of the present invention;

FIG. 3 is a block diagram of a location management means according to the embodiment of the present invention;

FIG. 4 is a view illustrating a home floor plan;

FIG. 5 is a view illustrating a bitmap coordinate system;

FIG. 6 is an overlapped view of the home floor plan of FIG. 4 and the bitmap coordinate system of FIG. 5;

FIG. 7 is a schematic view illustrating information stored in each pixel of a bitmap data structure; and

FIG. 8 is a flowchart of a method for managing location information for a home network according to the embodiment of the present invention.

### DETAILED DESCRIPTION OF EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

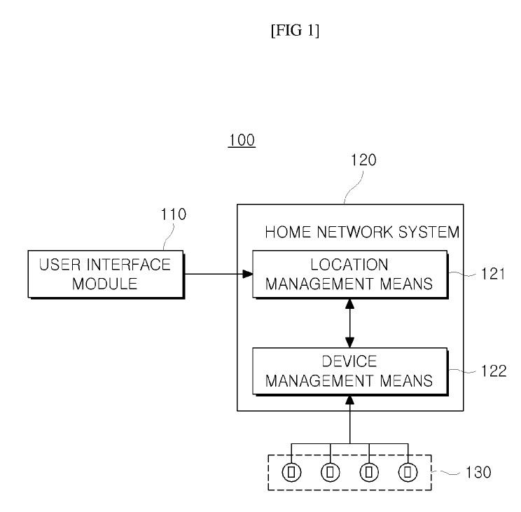

FIG. 1 is a block diagram of a system for managing location information for a home network according to an embodiment of the present invention. As shown in FIG. 1, a location information management system 100 of the home network includes a device management means 122, a location management means 121, and a user interface module 110. The device management means 122 collects information of home network devices 130 to form a device table. The location management means 121 generates a space data structure of a gridded home floor plan, and associates the device table with the space data structure on the basis of the device locations. The user interface module 110 receives input of a location of the home network devices 130, and transmits the location information to the location management means 121. The location information management system may further include a transmission means (not shown) for transmitting the device data to a home network server.

The device management means 122 obtains a list of the home network devices 130 to form a device table, and then performs overall management on those home network devices 130. The device table may include an index, an identifier, an attribute, and location information of each device.

In more detail, the device management means 122 and each of the home network devices 130 are assigned respective Internet Protocol (IP) addresses by a dynamic host configuration protocol (DHCP) server (not shown). The home network device multicasts universally unique identifier (UUID) data, and the uniform resource locator (URL) indicating a data location where device information thereof is stored to the device management means 122 by using the assigned IP address thereof. Then, the device management means 122 recognizes the network device through the UUID, and requests the network device to fetch data indicated by the URL.

Under the request of the device management means 112, the home network device 130 transmits a description file including various detailed device information and service information to the device management means 122. Then, the device management means 122 can control and operate the connected home network devices 130 based on description files transmitted in the aforementeiond manner. The description file is basically provided with an extensible markup language (xml) specification.

The device management means 122 having passed through the above series of operations generates a device table including information of the devices belonging to the home network on the basis of the collected information.

The user interface module 110 includes a display unit on which a home floor plan and each device icon are displayed, a user input unit through which input of a location and kind of the device is received from a user, and an input/output (I/O) unit (not shown) for transmitting/receiving data with the location management means 121. The user input unit may be a pointing means, e.g., a mouse or a stylus pen.

In more detail, the user interface module 1110 designates a location and kind of a device through a user interface program executed in, e.g., a PDA, a web pad or a PC, and sends this information to the location management means 121 within the home network system 120.

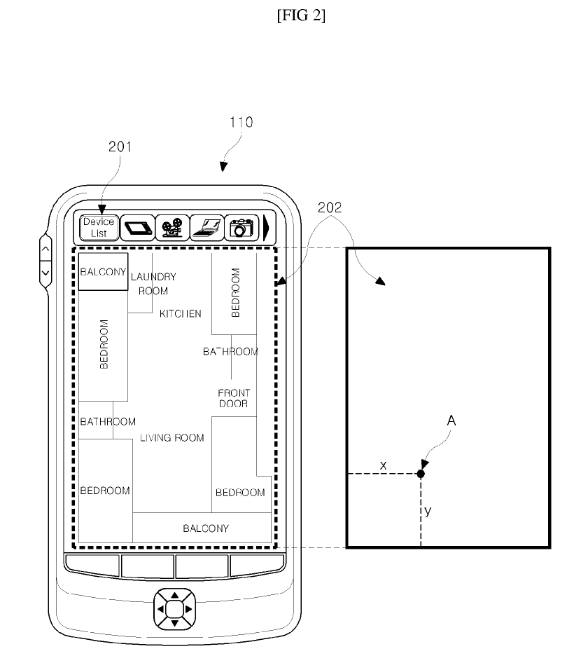

FIG. 2 is a schematic view illustrating the user interface module 110 according to the embodiment of the present invention. As shown in FIG. 2, icons 201 of obtained devices of the home network system 120 are listed on an upper portion of a screen of the user interface module 110, and a user's home floor plan 202 is displayed on a central region of the screen.

The user selects the icon 120 of a device to be placed, and points a location (A) in the home floor plan with a mouse or a stylus pen. The pointed device location (A) corresponds to coordinates of a bitmap image displayed on the user interface module 110.

When the device location (A) is pointed on the user interface module 110, a corresponding resolution and (x, y) coordinates of a bitmap are extracted through computation, and resulting information is transmitted to the location management means 121.

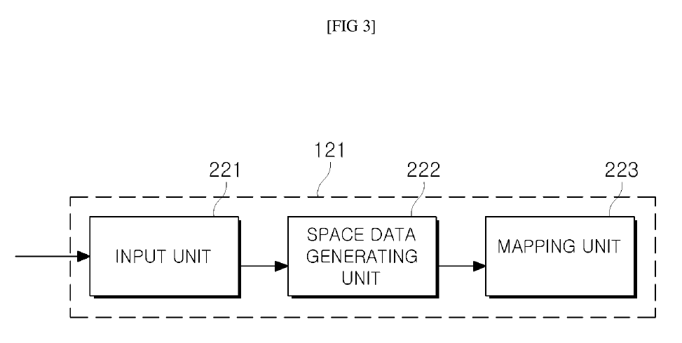

As shown in FIG. 3, the location management means 121 includes an input unit 221, a space data generating unit 222, and a mapping unit 223. The input unit 221 receives a home floor plan and dimension information. The space data generating unit 222 grids the home floor plan, and generates a two-dimensional space data structure including bitmap records each including two-dimensional coordinates for each grid, and a home space pattern in which each grid is placed. The mapping unit 223 associates the space data structure with the device in the device table 620 on the basis of the two-dimensional coordinates of the grid corresponding to the device location.

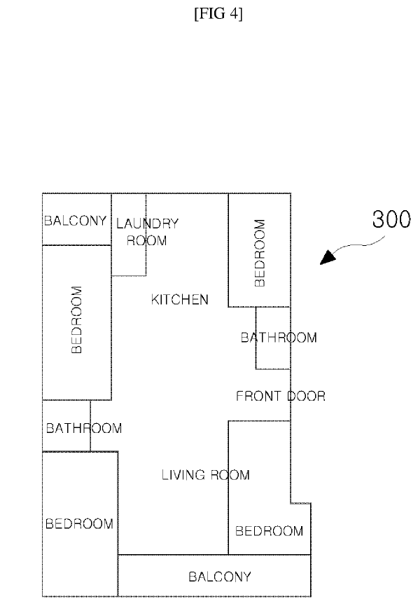

A process in which the location management means 121 forms the space data structure, i.e., a bitmap data structure will now be described in detail with reference to FIGS. 4 through 6.

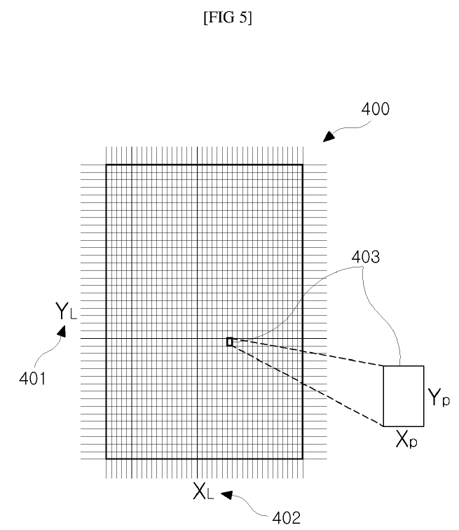

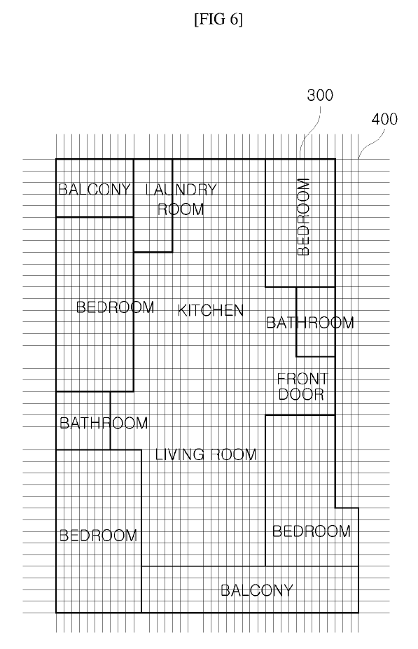

FIG. 4 is a view illustrating a home floor plan, FIG. 5 is a view illustrating a bitmap coordinate system, and FIG. 6 is an overlapped view of the home floor plan of FIG. 4 and the bitmap coordinate system of FIG. 5.

As shown in FIGS. 4 through 6, the bitmap coordinate system 400 corresponds to a home floor plan 300. To apply the two-dimensional coordinate system to the home floor plan 300, a length of an y-axis (Y_{L}) and a length of an x-axis (X_{L}) must be defined. Also, basic units for a single bitmap pixel 403, i.e., a y-axis unit (Y_{P}) and an x-axis unit (X_{P}) must be defined. The size of the pixel 403 is proportional to accuracy of the location information of the home floor plan 300 and the bitmap coordinate system 400. The bitmap coordinate system 400 corresponds to the bitmap data structure.

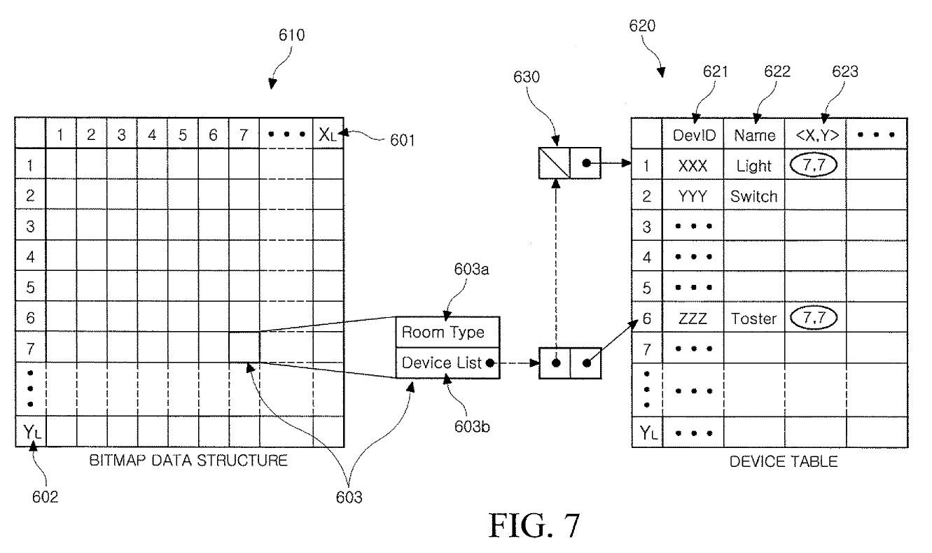

FIG. 7 is a schematic view illustrating the bitmap data structure. Referring to FIG. 7, a bitmap data structure 610 includes a plurality of bitmap records 603 each including two-dimensional location information including home space information 603a and device information 603b. The bitmap data structure 610 has the same two-dimensional structure as the gridded home floor plan (see FIG. 5). Thus, information is mapped through cross-reference to the bitmap data structure 610 and a device table 620 of the device management means 122.

In more detail, initialization information is inserted into the bitmap data structure 610 by a home network provider. The bitmap data structure 610 must coincide with pixel information corresponding to bitmap coordinates.

That is, the bitmap data structure 610 is generated corresponding to the gridded home floor plan. In each bitmap record 603, home space information is recorded in a Room Type field 603a. Examples of the home space information include space pattern information of a living room, a kitchen, a bedroom and so on. The device information is not included in the bitmap data structure 610 right after the initialization process.

When home network initialization and device plug-in processes are completed, the home network system obtains a list of every device that is currently present on the home network.

If a user points a location of a device on the user interface module 110 of FIG. 2 after the bitmap data structure 610 and the device list are prepared, a device record 630 corresponding to a pixel value of the pointed location is generated, and is associated with a bitmap record 603. This may be implemented by providing the bitmap record 603 with a pointer indicating the corresponding device record.

The device record 630 stores device index information of the device table 620, and connects it with each device. The device index information stored in the device record 630 may include information of a plurality of devices. That is, if a plurality of devices, e.g., a lamp on the ceiling and a toaster underneath, are placed at the same location within a home, one bit map record must be associated with a plurality of device records.

In this case, a device record for an initially pointed device may include an address of another device record for a subsequently pointed device.

Two-dimensional coordinates of a pixel are input to a location information field 623 of the device table 620. The device table 620 includes management identification (ID) information 621 and a device name 622 of each of devices.

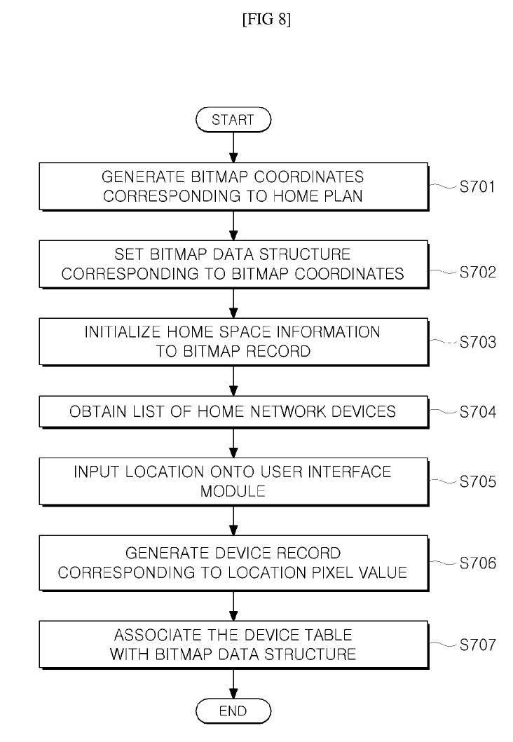

FIG. 8 is a flowchart of a method for managing location information for a home network according to the embodiment of the present invention. As shown in FIG. 8, in operation S701, a home floor plan and dimension information are input to grid the home floor plan, and a two-dimensional space data structure (hereinafter, referred to as a bitmap data structure) including a plurality of bitmap records each including two-dimensional coordinates of each grid and a home space pattern in which each grid is placed is generated.

In more detail, a bitmap coordinate system 400 having two-dimensional coordinates for each grid is formed corresponding to a home floor plan 300. To apply the two-dimensional coordinate system 400 to the home floor plan 300, a length of a y-axis and a length of an x-axis must be defined. Also, basic units of one bitmap pixel, i.e., a vertical unit and a horizontal unit must be defined. The size of the pixel is proportional to accuracy of location information.

In operation S702, a bitmap data structure 610 in which the bitmap coordinates correspond to pixel information is set. In operation S703, initialization is performed by mapping home space information to a bitmap record 603. That is, the bitmap coordinate system 400 corresponds to the bitmap data structure 610, and the home space information and bitmap records 603 of device information constituting the bitmap data structure 610 are generated, initialized.

In other words, the home floor plan 300 is gridded by applying the bitmap including a plurality of unit pixels to the home floor plan 300. In each bitmap record 603 of the bitmap data structure 610, a Room Type field is initialized.

Then, information of home network devices is collected to form a device table associated with the two-dimensional space data structure.

After the bitmap data structure 610 is initialized, a home network device list is obtained in operation S704. The device management means 122 obtains the list of the home network devices to form a device table 620, and manages the entire devices.

The home network transmits a description file including various detailed device information and service information to the device management means 122. The device management means 122 controls and operates the home network devices connected thereto on the basis of transferred description files. The description file is provided basically with the extensible markup language (xml) specification.

The device table includes an index, an identifier, an attribute and location information of each device.

A location of the home network is input in operation S705, and a device record 630 is generated in operation S706.

That is, when the location of the home network device is pointed with a mouse or a stylus pen, two-dimensional coordinates and device attribute information, e.g., a device kind, corresponding to the pointed location are transmitted to the location management means 121. Then, the location management means 121 generates a device record 630 corresponding to the pointed device, and associates the bitmap record 603 corresponding to the two-dimensional coordinates with the device record 630.

Also, the device record 630 stores corresponding device index information of the device table 620, and connects it with each device. The device index information stored in the device record 630 may include information of a plurality of devices.

Because the device record 630 includes an index about a device within the device table, the bitmap data structure 610 and the device table 620, specifically the bitmap record 603 and the device information within the device table 620 are associated with each other on the basis of the device record 630 in operation S707.

Also, two-dimensional coordinates are stored in a location information field for each device of the device table.

After the preceding processes are completed, the device table 620 or the device table 620 and the bitmap data structure 610 are transmitted to a home network server to be used for home device management.

Accordingly, since the location information of the home network devices is directly received through the user interface to be managed, more accurate location-based home network service can be provided.

Although the home network system of a home concept has been described according to the embodiments, the present invention is not limited thereto and may be applied, in the broad sense, to cover, e.g., services or middleware for convergence/control/operation between home network devices.

In the system and method for managing location information for a home network, location information of home network devices is directly input through a user interface, so that accurate location-based home network service can be provided.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

For example, initialization of the bitmap data structure is performed by a separate provider according to the embodiments, but a user who is a resident may input a home floor plan or initialization data through a user interface module.

Also, the two-dimensional data structure is referred to as a bitmap data structure according to the embodiments, but this is not related to a specific image conversion format, e.g., windows bitmap format but is merely a term selected for the convenience in description and better understandings.

What is claimed is:

1. A system for managing location information for a home network, comprising:
a device management means for collecting information of home network devices to form a device table;
a location management means for generating a space data structure including a gridded home floor plan, and associating the device table with the space data structure on the basis of a location of the home network device; and
a user interface module for receiving a location of the home network device to transfer the input location information to the location management means.

2. The system of claim 1, wherein the device table includes an index, an identifier, an attribute, and location information of each device.

3. The system of claim 1, wherein the location management means comprises:
an input unit for receiving a home floor plan and dimension information;
a space data generating unit for gridding the home floor plan, and generating a two-dimensional space data structure including a bitmap record including two-dimensional coordinates of a grid and a home space pattern where the grid is placed; and
a mapping unit for associating the space data structure with the device within the device table on the basis of two-dimensional coordinates of a grid corresponding to the location of the device.

4. The system of claim 3, wherein the space data generating unit grids the home floor plan by applying a bitmap including a plurality of unit pixels to the home floor plan.

5. The system of claim 3, wherein when receiving location coordinates of the device, the mapping unit generates a device record about the device, and associates the device with a corresponding bitmap record on the basis of the device record.

6. The system of claim 5, wherein the device record includes index information of the corresponding device within the device table.

7. The system of claim 5, wherein the location management means inserts the two-dimensional coordinates into a column of the device table corresponding to index information of the device within the device table.

8. The system of claim 7, further comprising a transmission means for transmitting the device table to a home network server.

9. The system of claim 1, wherein the user interface module comprises:
a display unit for displaying the home floor plan and an icon of each device;
a user input unit for receiving input of a location and kind of the device from a user; and
an input/output unit for transmitting/receiving data with the location management means.

10. The system of claim 9, wherein the user input unit is a pointing means including a mouse or a stylus pen.

11. A method for managing location information for a home network, the method comprising:
receiving a home floor plan and dimension information to grid the home floor plan, and generating a two-dimensional space data structure including a plurality of bitmap records each including two-dimensional coordinates of each grid and a home space pattern in which each grid is placed;
collecting information of home network devices to form a device table associated with the two-dimensional space data structure; and
receiving location information of the home network device through a user interface module to associate the device table with the two-dimensional space data structure on the basis of the input location of the home network device.

12. The method of claim 11, wherein the associating of the device table with the two-dimensional space data structure comprises:
generating a device record for each device whenever a device location is input; and
causing the device table to correspond to a bitmap record on the basis of the device record.

13. The method of claim 11, wherein the device table includes an index, an identifier, an attribute, and location information of each device.

14. The method of claim 12, wherein the associating of the device table with the two-dimensional space data structure further comprises:
inputting two-dimensional coordinates of the device in a location information field of the corresponding device within the device table.

15. The method of claim 11, wherein the device record includes index information of the corresponding device within the device table.

16. The method of claim 11, wherein the receiving of the location information of the home network device comprises:
displaying the home floor plan and an icon of each device on the user interface module; and
receiving information of a location and kind of the device from a user.

17. The method of claim 16, wherein the receiving of the information of the location and kind of the device from the user uses a pointing device including a mouse or a stylus pen.

18. The method of claim 11, further comprising transmitting the device table to a home network server after the associating of the device table with the two-dimensional space data structure.
